(19) United States
(12) Patent Application Publication
(10) Pub. No.: US 2015/0341597 A1
(43) Pub. Date: Nov. 26, 2015

(54) METHOD FOR PRESENTING A VEHICLE'S ENVIRONMENT ON A DISPLAY APPARATUS; A DISPLAY APPARATUS; A SYSTEM COMPRISING A PLURALITY OF IMAGE CAPTURING UNITS AND A DISPLAY APPARATUS; A COMPUTER PROGRAM

(71) Applicant: Dr. Ing. h.c. F. Porsche Aktiengesellschaft, Stuttgart (DE)

(72) Inventor: Timo Maise, Ludwigsburg (DE)

(21) Appl. No.: 14/691,655

(22) Filed: Apr. 21, 2015

(30) Foreign Application Priority Data
May 22, 2014 (DE) 10 2014 107 235.9

(51) Int. Cl. H04N 7/18

(52) U.S. Cl. CPC H04N 7/181

(57) ABSTRACT

A method for presenting a vehicle's environment on a display apparatus includes capturing a plurality of image sections by recording via an image capturing unit a plurality of pixels for forming an image section. The method proceeds by merging the plurality of image sections to form an environment image representing the vehicle's environment. The method continues by presenting the environment image on the display apparatus and determining a pixel distance between at least one of the pixels and the image capturing unit. The method then automatically displays on the display apparatus the image section associated with the at least one pixel in dependence on the pixel distance and/or images the at least one pixel onto an imaged pixel in the environment image in dependence on the pixel distance.

### CROSS REFERENCE TO RELATED APPLICATION

This application claims priority under 35 USC 119 to German Patent Appl. No. 10 2014 107 235.9 filed on May 22, 2014, the entire disclosure of which is incorporated herein by reference.

### BACKGROUND

1. Field of the Invention

The invention relates to a method for presenting a vehicle's environment on a display apparatus, to a display apparatus, to a system comprising a plurality of image capturing units and a display apparatus, and to a computer program.

2. Description of the Related Art

Methods for presenting the vehicle's environment on a display apparatus are known as parking assistants for assisting the driver when parking by viewing the display apparatus that typically is incorporated in the dashboard. The display apparatus is supplied with image material by an image capturing unit, such as a camera. Such an image capturing unit can be mounted on vehicles so that an image section captured by the image capturing unit gives a driver visual access to an area that would otherwise be hidden to the driver during traditional use of his rear-view mirror or when looking over the driver's shoulder. To be in a position to effectively use the display apparatus, the driver must be able to rely on the environment image presented in the display apparatus. A precondition of this is an image that is to scale, in which the vehicle's environment is presented over as large an area as possible, without relevant parts being lost during imaging or during further processing of the image.

To generate images of the environment that are as large as possible, typically image sections are merged or fused, and the image sections are recorded in each case by an image capturing unit. For this, two image capturing units are integrated or incorporated for example in a bumper of the vehicle, and two further image capturing units are integrated or incorporated in external mirrors of the vehicle. Typically, the driver can manually select between presentations on the display apparatus in which the merged environment image and/or at least one image section that is isolated from the environment image and only part of the environment image is presented. The methods known from the prior art have the disadvantage that distortions can occur in the environment image if pixels that are displaced in terms of height relative to one another are imaged. In addition, relevant pixels can be lost during the imaging into the environment image.

It is the object of the present invention to provide an uncomplicated method with which it is possible to show in the environment image on the display apparatus an image of the vehicle's environment that is as true to scale as possible without having to fear loss of relevant pixels.

### SUMMARY OF THE INVENTION

The object of the invention is achieved by a method for presenting a vehicle's environment on a display apparatus, wherein in a first method step, plural image sections are captured with image capturing units by recording via in each case one image capturing unit a plurality of pixels for forming an image section. In a second method step, plural image sections are merged to form an environment image representing the vehicle's environment. In a third method step, the environment image is presented on the display apparatus. In a fourth method step, a pixel distance between at least one of the pixels and the image capturing unit is determined. In a fifth method step the image section associated with the at least one pixel is displayed on the display apparatus in dependence on the pixel distance and/or the at least one pixel is imaged onto an imaged pixel in the environment image in dependence on the pixel distance.

In contrast to the prior art, it is hereby possible, by determining the pixel distance, to both match, in particular correct, the imaging of the at least one pixel onto the imaged pixel in the environment image and also to control the form of presentation in the display apparatus in an automated fashion if it is feared that a pixel is not accounted for in the display apparatus. The pixel distance is used here for two substantially different improvements during the presentation of the vehicle's environment on the display apparatus. This makes the method comparatively uncomplicated, since it is possible to omit additional monitoring or correcting measurements. Provision is made by the invention for the pixel distance to determine the location in the environment image at which the at least one pixel is imaged. As a result, a height displacement between individual pixels can be captured as closely to reality as possible. In addition, the pixel distance can be used to automatically ensure that a switch is made automatically from an environment image mode, in which only the merged environment image is shown in the display apparatus, to a supplementation mode in which at least one image section of the plurality of image sections is shown in the display apparatus. This is advantageous when it is feared that a pixel that is relevant for using the display apparatus would otherwise not be transferred to or imaged into the environment image.

The display apparatus preferably is integrated in a vehicle interior, for example in a dashboard, and is located in the field of view of the driver who is informed of the vehicle environment by the environment image shown by the display apparatus. The environment image then can be used by the driver advantageously as parking assistant. Image capturing units can be located at different locations on the body of the vehicle. The image capturing units may be arranged on a bumper, and further image capturing units may be arranged on an external mirror of the vehicle. As a result, it is possible to present the vehicle's environment over as large an area as possible, which advantageously facilitates the overview for the driver. The environment image also may present the vehicle's environment from a bird's eye perspective, i.e. as plan view.

In a further embodiment, provision is made for an environment sensor system and/or the image capturing unit to be used to determine the pixel distance. As a result, the pixel distance can be determined in a simple and uncomplicated manner. In particular, the pixel distance is determined for a plurality of pixels one-by-one or individually to realize an image that is as true to scale as possible and thus close to reality.

In a further embodiment, provision is made for the image section associated with the at least one pixel to be presented automatically in isolated fashion if it is determined that the at least one pixel having a pixel distance below a critical value is absent in the merged environment image. The pixels in the vicinity of the vehicle are of interest for example for parking, in particular for reverse parking. If such pixels in the vicinity of the vehicle are omitted in the environment image, for example by fusing the image sections, the passenger cannot trust the environment image presented in the imaging apparatus. By automatically taking account of the pixels in the vicinity of the vehicle, the use of the display apparatus can thus be improved.

Provision may be made for the at least one pixel located in a field of view of the image capturing unit to be projected onto a transformation plane for the purpose of imaging. Projecting the at least one pixel onto the transformation plane defines the position of the imaged pixel in the environment image. The transformation plane is a plane that is substantially parallel to the plane of main extent of a body floor of the vehicle. A field of view of the image capturing unit may be aligned substantially with the transformation plane. Pixels that cannot be projected onto the transformation plane, for example because they are located above the image capturing unit, could be lost under certain circumstances. The automatic switching or addition of the corresponding individual and thus isolated image section prevents such a pixel from not being taken into account by the display apparatus. A practical example here is reverse parking into a parking spot that is limited at the rear end by a railing situated at a higher level.

The at least one pixel may be projected onto the transformation plane along a direction that is substantially perpendicular to the transformation plane. Instead of following a viewing direction comprised by the field of view of the image capturing unit during the projection, at least one pixel that is displaced in terms of height with respect to the transformation plane may be projected along the direction that is perpendicular to the transformation plane. As a result, distortion, i.e. optical deformation, of the imaged pixel in the environment image is suppressed and imaging of the vehicle's environment onto the display apparatus that is as true to scale as possible is effected.

To achieve distortion-free imaging, the pixel distance may be used for projecting the at least one pixel onto a transformation plane. In particular, it is possible on account of the pixel distance to determine at what distance from the vehicle the projection onto the transformation plane should be effected. As a result, a horizontal imaging distance that corresponds to a horizontal real distance is ensured when imaging the pixels into the environment image. Consequently, distortion is advantageously is suppressed during imaging and a true-to-scale environment image is realized.

Provision may be made for an isolated presentation of the image section associated with the at least one pixel to be presented together with the environment image on the display apparatus. Thus, no information is lost to the driver when automatically switching between the presentation forms and his view of the vehicle's environment is not limited by the display apparatus.

The invention also relates to a display apparatus for presenting a vehicle's environment. The display apparatus can be used to reproduce an environment image according to a method of the invention.

The invention also relates to a system comprising a plurality of image capturing units and a display apparatus. A method according to the invention can be realized with the plurality of image capturing units and the display apparatus.

A computer program product with program coding is provided and, when incorporated into the control unit of the vehicle, enables the steps of the method of the invention to be carried out if the computer program is executed on a programmable device or on a system for presenting a vehicle's environment on a display apparatus.

Further details, features and advantages of the invention result from the drawings and from the following description of preferred embodiments with respect to the drawings. The drawings illustrate only exemplary embodiments of the invention and do not limit the scope of the invention.

### BRIEF DESCRIPTION OF THE DRAWINGS

FIG. 1A shows a prior method for presenting a vehicle's environment on a display apparatus and FIG. 1B shows an embodiment of the invention.

### DETAILED DESCRIPTION OF THE PREFERRED EMBODIMENTS

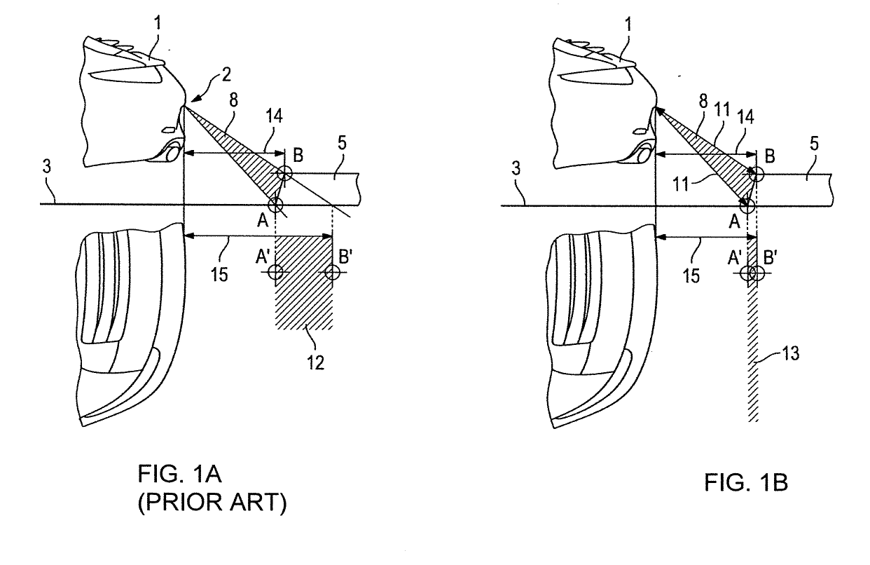

FIG. 1A schematically illustrates a method according to the prior art for presenting a vehicle's environment on a display apparatus, while FIG. 1B schematically illustrates a method for presenting a vehicle's environment on a display apparatus according to an exemplary embodiment of the present invention. In each case the upper portions of the figures show side views of a vehicle 1, and the bottom portions in each case show a plan view as is selected for example also as the view in the display apparatus. In particular, the respective bottom image corresponds to a possible environment image shown in the display apparatus. Provision is made for the method for presenting the vehicle's environment to be used as a parking assistant and for a driver of the vehicle 1 to be assisted during parking by viewing the display apparatus that preferably is incorporated in the dashboard. The display apparatus is a monitor on which the vehicle's environment is presented. For this purpose, image capturing units 2, such as cameras, are mounted on the vehicle 1. For example, one or more image capturing units 2 are integrated in a bumper of the vehicle 1. However, at least one further image capturing unit 2 can be mounted on an external mirror of the vehicle 1. Provision also is made for a plurality of image capturing units 2 to be aligned substantially along a common preferential direction, such as along a rearward direction of the vehicle 1 and for the individual image capturing units 2 of the plurality of image capturing units 2 to record in each case individual image sections. For presenting the environment, plural image sections are merged to form an environment image. The environment image that is fused from the individual image sections is presented in the display apparatus. To obtain an impression of the vehicle's environment that is as close to reality as possible, it is desirable for the environment image to be presented in a manner that is to the greatest possible extent free of distortion, i.e. without optical deformation. Such distortion occurs if an object 5 is located in the field of view 8 of the image capturing unit 2, as a result of which pixels A and B to be imaged are arranged in a manner that is displaced in terms of height with respect to one another and in particular with respect to a transformation plane 3 (along which the vehicle 1 is substantially aligned). Provision is made for a body floor to be substantially parallel to the transformation plane 3. The projection of the pixel B that is displaced in terms of height onto the transformation plane 3 along a viewing direction specified by the field of view then, without any further measures, results in the undesired distortion in the final environment image. A horizontal image distance 15 between the vehicle 1 and the image pixel B′ that is displaced in terms of height is, on account of the imaging using the image capturing unit, presented as longer than a horizontal real distance 14 between the pixel B that is displaced in terms of height and the vehicle 1.

To counteract this distortion, provision is made for a pixel distance 11 to be determined, where the pixel distance 11 is defined by the distance between the pixel A or B to be imaged and the image capturing unit 2. In particular, the respective pixel distance 11 to a plurality of pixels A and B is determined. Here, the image capturing unit and/or an additional environment sensor system is used to determine the pixel distance 11. For the pixels A and B located in the field of view, it is possible together with the respective pixel distance to correct the pixels A′ and B′ imaged in the environment image so that the vehicle's environment is imaged onto the environment image in a manner that is to scale. In particular, the correction ensures that the horizontal imaging distance 15 between the vehicle 1 and the imaged pixel B′ that is displaced in terms of height corresponds to the horizontal real distance 14 between the vehicle 1 and the pixel B′ that is displaced in terms of height. To this end, the pixel distance 11 is used to project onto the transformation plane 3, for the true-to-scale image, the pixel B that is displaced in terms of height along a direction that is substantially perpendicular to the transformation plane 3. What is also conceivable is for pixel distances 11 to be determined for primary pixels that are distributed regularly across the image section and for the remaining pixel distances 11 for secondary pixels located between the primary pixels to be interpolated on the basis of the pixel distances 11 determined for the primary pixels. Provision further is made for the pixel distance 11 to be used not only for image matching in the form of the described imaging correction, but also for determining whether an individual image section is presented as isolated from the environment image in the display apparatus. To this end, provision is made for a check to be carried out as to whether a pixel A or B, the pixel distance 11 of which has fallen short of a critical value, is absent in the merged environment image. Under the precondition that the pixel A or B is absent, the image section preferably is presented automatically as isolated from the environment image or made available to the driver, individually or as isolated from the environment image. The isolated image section preferably is presented in the display apparatus. By automatically switching the presentation for the relevant image section, it is ensured advantageously that no pixels A or B that are lost when fusing or merging the image sections are disregarded if the pixel A or B to be imaged is located in the direct vicinity of the vehicle. Preferably, the switching is associated with an optical and/or acoustic warning signal. As a result, the likelihood that pixels A or B that are relevant for example when parking the vehicle 1 are lost for the passenger or driver when viewing the display apparatus advantageously is reduced.

What is claimed is:

1. A method for presenting a vehicle's environment on a display apparatus, comprising:
capturing a plurality of image sections with image capturing units by recording for each image capturing unit a plurality of pixels for forming an image section;
merging the plurality of image sections to form an environment image representing an environment of the vehicle;
presenting the environment image on the display apparatus;
determining a pixel distance between at least one pixel and the image capturing unit;
using the pixel distance for automatically displaying the image section associated with the at least one pixel on the display apparatus in dependence on the pixel distance and/or imaging the at least one pixel onto an imaged pixel in the environment image in dependence on the pixel distance.

2. The method of claim 1, wherein an environment sensor system and/or the image capturing unit is used for determining a pixel distance between at least one pixel and the image capturing unit.

3. The method according of claim 2, wherein the image section associated with the at least one pixel is presented automatically as isolated from the merged environment image if it is determined that the at least one pixel having a pixel distance below a critical value is absent in the merged environment image.

4. The method of claim 2, further comprising projecting the at least one pixel located in a field of view of the image capturing unit onto a transformation plane for determining a position of the imaged pixel in the environment image, wherein the transformation plane is substantially parallel to the main extent of the vehicle.

5. The method of claim 4, wherein the at least one pixel is projected onto the transformation plane along a direction that is substantially perpendicular to the transformation plane.

6. The method of claim 5, wherein to achieve distortion-free imaging the pixel distance is used for projecting the at least one pixel onto the transformation plane.

7. The method of claim 1, wherein the isolated presentation of the image section associated with the at least one pixel is presented together with the environment image on the display apparatus.

8. A display apparatus for presenting a vehicle's environment, wherein the display apparatus being configured to reproduce an environment image according to the method of claim 1.

9. A system comprising a plurality of image capturing units and a display apparatus for carrying out the method of claim 1.

10. A computer program product that, when loaded on a control unit a display apparatus of a vehicle performs the method of claim 1.
